(19) United States
(12) Patent Application Publication
(10) Pub. No.: US 2022/0339668 A1
(43) Pub. Date: Oct. 27, 2022

(54) METAL COATING METHOD

(71) Applicant: HONDA MOTOR CO., LTD., Tokyo (JP)

(72) Inventor: Masayo TSUZUKI, Tochigi (JP)

(21) Appl. No.: 17/640,833

(22) PCT Filed: Jul. 13, 2020
(86) PCT No.: PCT/JP2020/027247

§ 371 Date: Mar. 7, 2022

(30) Foreign Application Priority Data
Sep. 27, 2019 (JP) 2019-177898

(51) Int. Cl. B05D 3/10; C23F 1/20; C23F 1/26; C23F 1/28; B05D 7/14

(52) U.S. Cl. CPC B05D 3/102; C23F 1/20; C23F 1/26; C23F 1/28; B05D 7/14

(57) ABSTRACT

The present invention aims to provide a metal coating method whereby a paint can be applied directly, easily, with high adhesion, and with cost increases suppressed, to the surface of titanium and other metals that have a hard passivated coating on the surface thereof. This method uses paint to coat a metal that has the surface thereof coated in a passivated coating and comprises: an etching step in which the passivated coating is removed using an etching solution and the surface is exposed; a diluent coating step in which, after the etching step, a diluent capable of diluting the paint is coated on the surface that is in a liquid-coated state; and a painting step in which the surface is coated in paint after the diluent coating step.

### TECHNICAL FIELD

The present invention relates to a metal coating method for coating a metal surface.

### BACKGROUND ART

Conventionally, metal parts such as automobile bodies and motorcycle tanks or frames have been coated. Steel is generally used as a material for such metal parts, but in recent years, titanium, aluminum (or alloys mainly composed of these metals), or stainless steel, which is more advantageous than steel in terms of corrosion resistance, weight reduction, and the like, have been intended to be applied to the metal parts, and have been put into practical use in some cases.

These types of metals were often used to give off a material feeling without being decorated by coating or the like, but decoration such as coating has been required to improve the commercial value. For example, a method of applying electrodeposition coating after removing the oxide film on the surface of an aluminum alloy with a degreasing treatment agent having an etching property (refer to, for example, Patent Document 1), or a method of color developing by anodizing after etching the surface of titanium (refer to, for example, Patent Document 2) are known. Regarding the technology for etching the surface of titanium, there is known the technology to form a gold plating by removing the oxide film on the substrate of the titanium by etching, followed by immersing it to a gold plating bath, in which an additive such as a fluorine compound that suppresses the formation of a passive film is added (refer to, for example, Patent Document 3).
Patent Document 1: Japanese Unexamined Patent Application, Publication No. HOI-279788
Patent Document 2: Japanese Unexamined Patent Application, Publication No. H02-50984
Patent Document 3: Japanese Unexamined Patent Application, Publication No. 2009-114522

### DISCLOSURE OF THE INVENTION

### Problems to be Solved by the Invention

Conventionally, steel has been coated by applying a paint to the surface thereof, and if a metal such as titanium can be coated by the same method as the coating on steel, it is preferable because the metal can be coated without major change of the process, which does not require the previously described conventional techniques or the like based on non-direct coating. When coating steel, pretreatment such as forming a phosphate film is usually performed in order to improve corrosion resistance and adhesion of the paint. However, since a metal such as titanium, aluminum, or stainless steel has a strong passive film (an oxide film) formed on the surface, it is difficult to form a phosphate film or the like on the surface, resulting in poor adhesion of the paint. Therefore, if a special treatment such as primer treatment or blast treatment is performed as another means for ensuring the adhesion, coating becomes possible, but the manufacturing cost increases.

In view of the above circumstances, it is an object of the present invention to provide a metal coating method whereby a paint can be coated directly and easily, in a high adhesion state, and also with cost increase suppressed, on the surface of a metal such as titanium that has a strong passive film on the surface.

### Means for Solving the Problems

(1) The metal coating method according to the present invention is a method for coating a metal that has a surface covered with a passive film, with a paint, comprising: an etching step of removing the passive film with an etching solution to expose the surface; a diluent covering step of covering the surface in a liquid-covered state with a diluent capable of diluting the paint after the etching step; and a coating step of applying the paint to the surface after the diluent covering step.

According to the above (1), the surface of the metal, from which the passive film has been removed by etching, becomes a rough surface having fine irregularities to which the paint easily adheres. Further, after the etching step, the roughened surface is covered with a diluent while the surface is still covered with the liquid, and in the coating step, the paint is applied to the surface in a state mixed with the diluent. Since the surface of the etched metal, from which the passive film has been removed, is always covered with liquid and does not contact with air, the formation of a passive film on the surface, which reduces the adhesion of the paint, can be suppressed. Therefore, it is not necessary to apply special treatment to the surface or significantly increase the number of steps, and the surface of the metal can be coated with the paint directly and easily, in a high adhesion state, and also with cost increase suppressed. The paint is applied to the metal surface in a state mixed with the diluent, but since the diluent used is a material compatible with the paint, that is, a type of diluent that can dilute the paint, it is possible to coat well without causing any problems such as deterioration of the paint even if the paint is applied to the surface covered with the diluent.

(2) In the metal coating method according to (1), the paint may be a water-based paint, and the diluent may be water or an alcoholic diluent.

(3) In the metal coating method according to (1), the paint may be a solvent-based paint, and the diluent may be an organic solvent.

According to the above (2) or (3), since a diluent compatible with the paint is used, even if the paint is applied to the surface of the metal in the state still covered with the diluent, it is possible to coat well without causing any problems such as deterioration of the paint.

(4) In the metal coating method according to any one of (1) to (3) above, examples of the metal include titanium and a titanium alloy.

(5) In the metal coating method according to any one of (1) to (3) above, examples of the metal include stainless steel.

(6) In the metal coating method according to any one of (1) to (3) above, examples of the metal include aluminum and an aluminum alloy.

Although a strong passive film (an oxide film) is formed on the surface of each of the metals listed in (4) to (6) above, the surface of the metals can be coated with the paint directly and easily, in a high adhesion state, and also with cost increase suppressed, according to the present invention.

(7) In the metal coating method according to any one of (1) to (6) above, the etching solution may be a reducing acid.

According to the above (7), the passive film can be easily removed without oxidizing the surface of the metal.

### Effects of the Invention

The present invention can provide a metal coating method whereby a paint can be applied directly and easily, in a high adhesion state, and also with cost increase suppressed, on the surface of a metal such as titanium that has a strong passive film on the surface.

### BRIEF DESCRIPTION OF THE DRAWINGS

FIG. 1 depicts a diagram showing a process of a metal coating method according to an embodiment of the present invention.

FIG. 2 depicts a diagram schematically showing a state in which a metal surface is coated by the method according to the embodiment.

### PREFERRED MODE FOR CARRYING OUT THE INVENTION

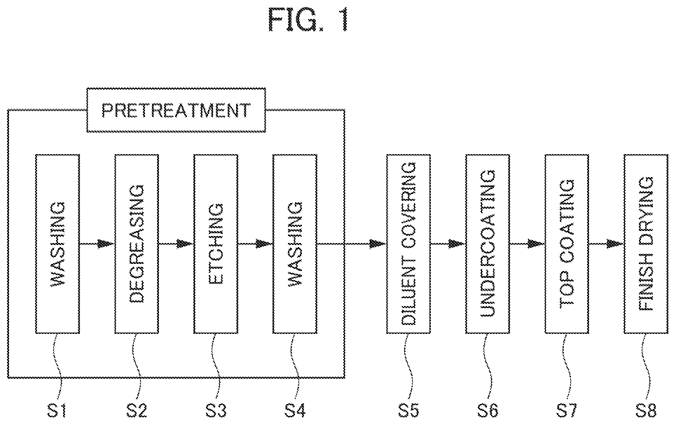

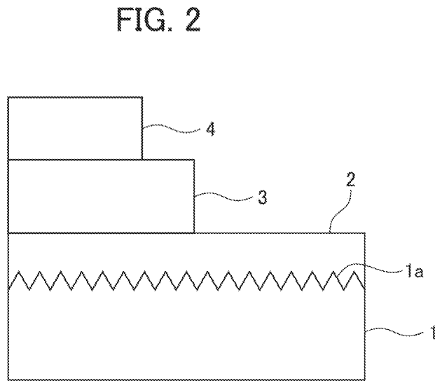

Hereinafter, an embodiment of the present invention will be described with reference to the drawings. FIG. 1 shows a process of a metal coating method of the present embodiment, and FIG. 2 schematically shows a state in which the surface 1a of a metal work 1, a component to be coated, is coated by the process.

The work 1 shown in FIG. 2 shows, for example, a base portion of a metal part such as an automobile body, a motorcycle tank or frame, but the work 1 is not limited to these parts. The work 1 is manufactured by processing a metal such as titanium or a titanium alloy, aluminum or an aluminum alloy, or stainless steel, which has a strong passive film (an oxide film) formed on the surface. Hereinafter, in the following description, the work 1 is made of titanium.

The coating method of the present embodiment will be described in sequence of the steps with reference to FIG. 1. In the coating method of the present embodiment, a pretreatment step is first carried out. In the pretreatment step, first, the surface of the work 1 is washed with water (step S1), and then the surface is degreased (step S2). For degreasing, known degreasing agents and degreasing methods can be adopted. Examples of the degreasing agents include, but are not limited to, solvent cleaning agents, alkaline degreasing agents, acidic emulsion degreasing agents, and the like. The degreasing method is appropriately selected according to the degreasing agent to be used.

After degreasing, etching is performed (step S3: etching step). The etching may be wet etching, and a known etching method, such as immersing the work 1 in the stored etching solution and bringing the etching solution into contact with the surface 1a of the work 1 for a predetermined time, can be used. The passive film formed on the surface of the work 1 is removed by the contact with the etching solution, and thus the surface thereof is exposed.

Examples of the etching solution used for wet etching include, but are not limited to, reducing acids, such as hydrochloric acid, sulfuric acid, tartaric acid, formic acid, malic acid, citric acid, oxalic acid, lactic acid, succinic acid, amino acids, glycolic acid, gluconic acid, malonic acid, itaconic acid, and maleic acid, or acid salts thereof, which are preferably used because they easily remove the passive film. The time for immersing the work 1 in the etching solution varies depending on the temperature of the etching solution and the like, but is, for example, about 0.5 to 3 minutes. The temperature of the etching solution and the etching time are appropriately controlled in order to prevent the surface of the work 1 from being excessively dissolved.

As shown in FIG. 2, the surface 1a of the work 1 after etching becomes a rough surface having fine irregularities.

After the etching step, the work 1 is washed with water to remove the etching solution from the surface 1a (step S4). This completes the pretreatment step.

Immediately after the last washing with water in the pretreatment step, a diluent covering step (step S5) is performed. The surface 1a of the work 1 after washing with water remains covered with the water (liquid content) used for washing. In the diluent covering step, as shown in FIG. 2, the surface 1a still covered with water is covered with a diluent 2 for paint. The diluent 2 can cover the surface 1a by immersing the work 1 in the pooled diluent 2 or applying the diluent 2 to the surface. As the diluent 2, a type of diluent is used that is compatible with the paint used in the next coating step and is capable of diluting the paint.

Next, a coating step of applying the paint to the surface 1a of the work 1 covered with the diluent 2 is performed. In the present embodiment, as shown in FIG. 2, an undercoat paint is applied to the surface 1a of the work 1 covered with the diluent 2 to form an undercoat layer 3 (step S6), and then, on the undercoat layer 3, a top coat paint is applied to form a top coat layer 4 (step S7). As a result, the diluent 2 dilutes the undercoat layer 3 to form coating films of the undercoat layer 3 and the top coat layer 4 on the surface 1a of the work 1. Known coating methods, such as baking coating or air-drying coating, for example, are adopted for coating the work 1.

As paints used for undercoating and top coating, for example, a water-based paint, a solvent-based paint, and the like can be used. As the diluent 2 that covers the surface 1a of the work 1 in the diluent covering step, a type of diluent capable of diluting the paint is used, as described above. That is, when a water-based paint is used as the undercoat paint, water or an alcoholic diluent such as IPA (isopropanol) is used as the diluent 2. When a solvent-based paint is used as the undercoat paint, an organic solvent such as thinner is used as the diluent 2.

Then, after the coating step, finish drying is performed to complete the coating (step S8). After that, clear coating may be applied as needed, and a resin film for design may be attached before the clear coating.

The above is the coating method of the present embodiment, and according to the present embodiment, the surface 1a of the work 1 from which the passive film has been removed by etching has a rough surface having fine irregularities to which the paint easily adheres. Then, after the etching step, the roughened surface 1a is covered with the diluent 2 while the surface 1a is still covered with water used for washing, and in the coating step, the paint is applied to the surface 1a in a state mixed with the diluent 2. That is, there is no step of drying the work 1 between the last washing with water in the pretreatment and the undercoating.

From these, the surface 1a after etching, from which the passive film has been removed, is always covered with liquid and does not contact with air. Therefore, the formation of a passive film on the surface 1a, which reduces the adhesion of the paint, can be suppressed. As a result, even if the work 1 is made of titanium having a strong passive film formed on the surface 1a, it is not necessary to apply special treatment to the surface 1a or significantly increase the number of steps, and the surface 1a can be coated with the paint directly and easily, in a high adhesion state, and also with cost increase suppressed.

By using a reducing acid as the etching solution used in the etching step, the passive film can be easily removed without oxidizing the surface 1a of the work 1.

Since the surface 1a of the work 1 is washed with water after etching, the etching solution will not be mixed with the diluent 2 that will cover the surface 1a thereafter. Therefore, the coating can be performed well without being affected by the etching solution. If the etching solution can be removed from the surface 1a by covering it with the diluent 2, the washing step after etching may be omitted.

The undercoat paint to be applied to the surface 1a of the work 1 is applied to the surface 1a in a state mixed with the diluent 2, but since the diluent 2 used is a material compatible with the paint, that is, a type of diluent that can dilute the paint, it is possible to coat well without causing any problems such as deterioration of the paint even if the paint is applied to the surface 1a covered with the diluent 2.

Although the above embodiment has been described assuming that the work 1 is made of titanium, the present invention is effective as a method of coating a metal having a strong passive film formed on the surface, in addition to titanium. In addition to titanium, such metals include titanium alloy, aluminum or aluminum alloy, and stainless steel. Therefore, by applying the coating method of the above embodiment to these metals, they can be coated with a paint directly and easily, in a high adhesion state, and also with cost increase suppressed.

### EXPLANATION OF REFERENCE NUMERALS

1 work (metal)
1a surface
2 diluent
3 undercoat layer
4 top coat layer

1. A metal coating method for coating a metal that has a surface covered with a passive film, with a paint, comprising:
an etching step of removing the passive film with an etching solution to expose the surface;
a diluent covering step of covering the surface in a liquid-covered state with a diluent capable of diluting the paint after the etching step; and
a coating step of applying the paint to the surface after the diluent covering step.

2. The metal coating method according to claim 1, wherein the paint is a water-based paint, and the diluent is water or an alcoholic diluent.

3. The metal coating method according to claim 1, wherein the paint is a solvent-based paint, and the diluent is an organic solvent.

4. The metal coating method according to claim 1, wherein the metal is titanium or a titanium alloy.

5. The metal coating method according to claim 1, wherein the metal is stainless steel.

6. The metal coating method according to claim 1, wherein the metal is aluminum or an aluminum alloy.

7. The metal coating method according to claim 1, wherein the etching solution is a reducing acid.

8. The metal coating method according to claim 2, wherein the metal is titanium or a titanium alloy.

9. The metal coating method according to claim 3, wherein the metal is titanium or a titanium alloy.

10. The metal coating method according to claim 2, wherein the metal is stainless steel.

11. The metal coating method according to claim 3, wherein the metal is stainless steel.

12. The metal coating method according to claim 2, wherein the metal is aluminum or an aluminum alloy.

13. The metal coating method according to claim 3, wherein the metal is aluminum or an aluminum alloy.

14. The metal coating method according to claim 2, wherein the etching solution is a reducing acid.

15. The metal coating method according to claim 3, wherein the etching solution is a reducing acid.

16. The metal coating method according to claim 4, wherein the etching solution is a reducing acid.

17. The metal coating method according to claim 5, wherein the etching solution is a reducing acid.

18. The metal coating method according to claim 6, wherein the etching solution is a reducing acid.
